(19) United States
(12) Patent Application Publication
(10) Pub. No.: US 2025/0145314 A1
(43) Pub. Date: May 8, 2025

(54) Landing Platform

(71) Applicant: HHLA Sky GmbH, Hamburg (DE)

(72) Inventors: Matthias GRONSTEDT, Hamburg (DE); Olaf HILBIG, Kirchlengern (DE); Stefan OLUSCHINSKY, kIRCHLENGERN (DE); Marius SCHRODER, Bielefeld (DE)

(73) Assignee: HHLA Sky GmbH, Hamburg (DE)

(21) Appl. No.: 18/692,651

(22) PCT Filed: Sep. 15, 2022
(86) PCT No.: PCT/EP2022/075714

§ 371 Date: Oct. 10, 2024

(30) Foreign Application Priority Data
Sep. 16, 2021 (DE) 10 2021 123 990.7

(51) Int. Cl. B64U 70/99; B64F 1/32

(52) U.S. Cl. CPC B64U 70/99; B64F 1/322

(57) ABSTRACT

The invention relates to a landing platform for a drone (6), comprising a landing surface comprising two conveyor belts (2) which are arranged parallel in the same horizontal plane and which are spaced apart such that a drone (6) standing on the landing surface can simultaneously have contact with both conveyor belts (drone conveyor belts), two sliding bars (3) which each extend at least partially parallel to the running direction of the drone conveyor belts (2) and can be moved toward each other above the drone conveyor belts in a direction perpendicular to the running direction of the drone conveyor belts so that the sliding bars can slide a drone (6) standing on the landing surface, and a loading unit (5) comprising a lifting device (7) for cargo, the lifting device being arranged between the drone conveyor belts, wherein the drone (6) standing on the landing surface can be moved, by movement of the drone conveyor belts (2) and/or movement of the sliding bars (3), into a position in which the drone (6) can receive cargo arranged on the lifting device (7) (loading position).

The subject matter of the invention is a landing platform for a drone.

Transport drones in the form of multicopters and drones which can fly from a starting point to a destination point in a manner which is autonomous or remote controlled are known. Apparatuses for receiving consignments which have been transported by a drone are likewise known.

It is an object of the invention to provide a landing platform for a drone, which landing platform makes it possible that the drone can collect an item to be transported such as a package.

The object is achieved by way of a landing platform as claimed patent claim 1. Further advantageous embodiments are the subject matter of the subclaims or are described in the following text.

The landing platform according to the invention makes it possible in an advantageous way that, after it lands on the landing surface, a drone is conveyed automatically into a position, in which the drone can collect, for example pick up, an item to be transported. Here, the drone can not only fly and land autonomously, but rather can preferably also control the landing platform, in order to be moved by the conveyor belts and sliding bars into the suitable position and to receive an item to be transported provided for collecting from the lifting apparatus.

The drone conveyor belts are preferably configured as module conveyor belts. The individual elements of the module conveyor belts are preferably at least partially open, with the result that moisture can run off.

The landing surface, the sliding bars and the fitting unit are preferably attached to a framework.

The drone conveyor belts are preferably driven via an electric motor.

The sliding bars can preferably displace a drone in such a way that the drone is in contact at the same time with the two drone conveyor belts. Skids which are enclosed by a landing frame of the drone can preferably be moved by way of the sliding bars into a position parallel to the running direction of the drone conveyor belts. The sliding bars are preferably driven via a chain drive. The sliding bars are preferably made from profiled stainless steel. The sliding bars, when they move away from one another, can preferably push foreign objects situated on the landing surface such as, for example, small branches or leaves outward from the landing surface. The two end positions of a sliding bar (“outside” and “inside”) are preferably limited mechanically. The two end positions of the sliding bars (“outside” and “inside”) are preferably scanned by sensor.

In the case of the movement of the drone into the loading position, a landing frame of the drone is preferably aligned on a stop edge. In the case of the movement of the drone into the loading position, skids of a landing frame of the drone are preferably moved under two hold-down brackets. Reaching of the loading position is preferably scanned by way of a sensor system. Hold-down brackets preferably hold a landing frame of the drone while the drone collects an item to be transported which is arranged on the lifting apparatus.

The lifting apparatus is preferably configured as a scissors-type lifting table. The scissors-type lifting table can preferably be adjusted vertically via a self-locking spindle drive. The end positions of the lifting apparatus are preferably detected via sensors. The end positions of the lifting apparatus are preferably secured by way of safety stops against damage. The lifting apparatus is preferably driven via an electric motor and a flange-connected gear mechanism. The landing surface preferably has a size of at least 1.8 m by 1.8 m. This size makes it possible that the drone can land safely on the landing surface even when the drone is not ensured relatively accurate landings on account of external conditions or on account of inaccuracies in the control or localization.

The invention will be explained in greater detail on the basis of the figures which show one exemplary embodiment and in which:

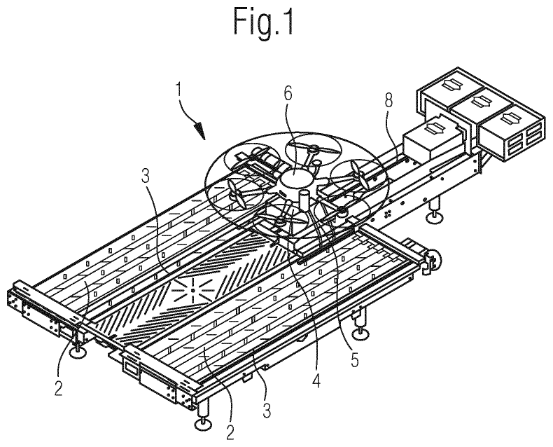

FIG. 1 shows a landing platform according to the invention with a drone and an item to be transported,

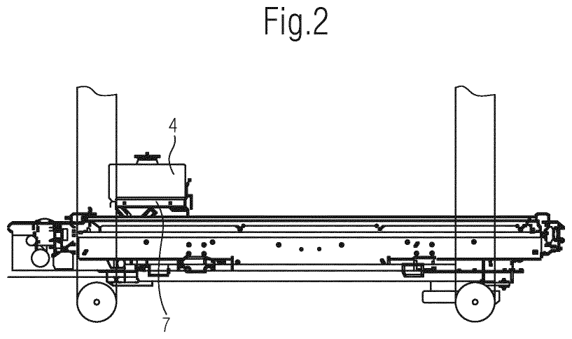

FIG. 2 shows a side view of a landing platform according to the invention with an item to be transported,

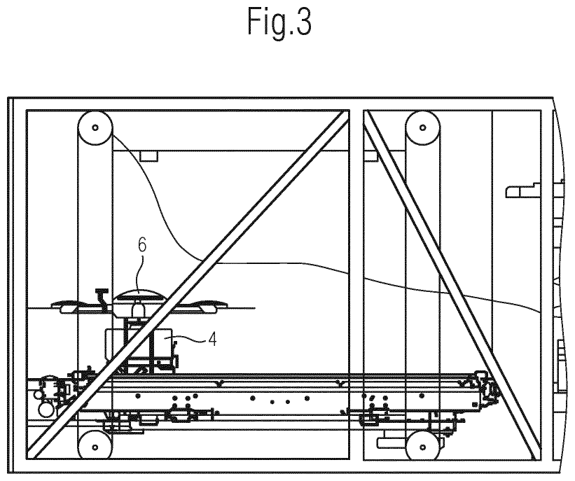

FIG. 3 shows a side view of a landing platform according to the invention with a drone and an item to be transported,

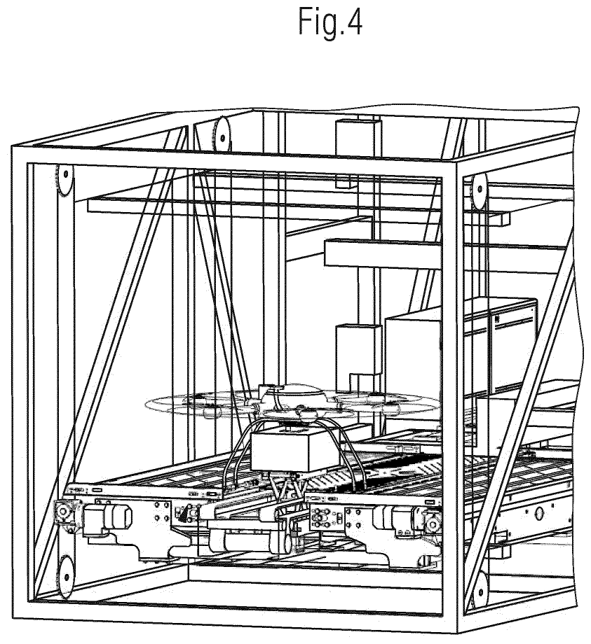

FIG. 4 shows a landing platform according to the invention with a drone and an item to be transported,

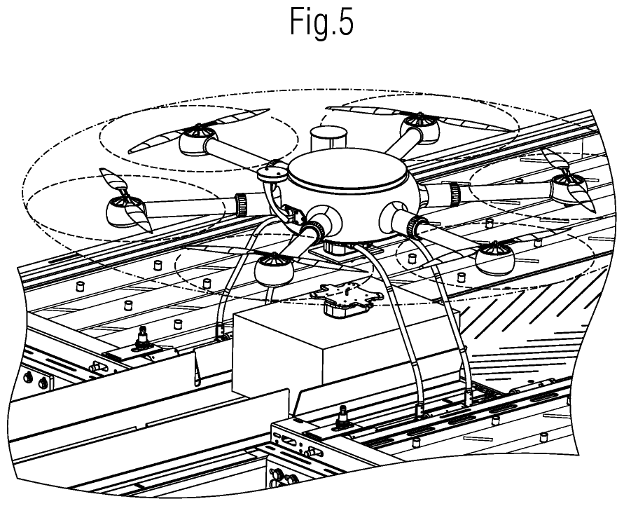

FIG. 5 shows a landing platform according to the invention with a drone and an item to be transported which has not been collected, and

FIG. 6 shows a landing platform according to the invention with a drone with an item to be transported which has been collected.

FIG. 1 shows a landing platform 1 comprising a landing surface which comprises two conveyor belts 2 which are arranged in parallel in the same horizontal plane and are spaced apart in such a way that a drone 6 standing on the landing surface can be in contact at the same time with the two conveyor belts 2 (drone conveyor belts 2), and two sliding bars 3 which each run parallel to the running direction of the drone conveyor belts 2 and can be moved toward one another above the drone conveyor belts 2 in a direction transversely with respect to the running direction of the drone conveyor belts 2, with the result that they can displace the drone 6 standing on the landing surface. The fitting unit 5 comprises a lifting apparatus 7, arranged between the drone conveyor belts 2, for a cuboid item to be transported 4. The drone 6 standing on the landing surface has been moved by way of movement of the drone conveyor belts 2 and/or movement of the sliding bars 3 into a position, in which the drone 6 can collect the item to be transported 4 which is arranged on the lifting apparatus (loading position). The fitting unit 5 also comprises a conveyor belt 8 for moving the item to be transported 4 onto the lifting apparatus 7 (transport item conveyor belt 8). The sliding bars 3 can displace the drone 6 in such a way that the drone 6 is in contact at the same time with the two drone conveyor belts 2. The drone 6 comprises a landing frame with skids which can be moved by way of the sliding bars 3 into a position parallel to the running direction of the drone conveyor belts 2. The landing frame of the drone 6 has been aligned on a stop edge in the case of the movement into the loading position.

FIG. 2 shows, in particular, a lifting apparatus 7 which belongs to the fitting unit 5 and is configured as a scissors-type lifting table. The item to be transported 4 is situated on the lifting apparatus.

FIGS. 3 and 4 likewise show, in particular, the lifting apparatus 7 which belongs to the fitting unit 5 and is configured as a scissors-type lifting table. The item to be transported 4 is situated on the lifting apparatus, with the result that the former can be gripped by the drone 6.

1.-24. (canceled)

25. A landing platform for a drone comprising
a landing surface comprising
two conveyor belts which are arranged in parallel in the same horizontal plane and are spaced apart in such a way that a drone standing on the landing surface can be in contact at the same time with the two conveyor belts (drone conveyor belts),
two sliding bars which each run at least partially parallel to the running direction of the drone conveyor belts and can be moved toward one another above the drone conveyor belts in a direction transversely with respect to the running direction of the drone conveyor belts, with the result that they can displace a drone standing on the landing surface, and
a fitting unit comprising a lifting apparatus, arranged between the drone conveyor belts, for an item to be transported,
wherein the drone standing on the landing surface can be moved by way of movement of the drone conveyor belts and/or movement of the sliding bars into a position, in which the drone can collect an item to be transported which is arranged on the lifting apparatus (loading position).

26. The landing platform as claimed in claim 25, wherein the fitting unit comprises a conveyor belt for moving the item to be transported onto the lifting apparatus (transport item conveyor belt).

27. The landing platform as claimed in claim 25, wherein the drone conveyor belts are configured as module conveyor belts.

28. The landing platform as claimed in claim 27, wherein the individual elements of the module conveyor belts are at least partially open, with the result that moisture can run off.

29. The landing platform as claimed in claim 25, wherein the landing surface, the sliding bars and the fitting unit are attached to a framework.

30. The landing platform as claimed in claim 25, wherein the drone conveyor belts are driven via an electric motor.

31. The landing platform as claimed in claim 25, wherein the sliding bars can displace a drone in such a way that the drone is in contact at the same time with the two drone conveyor belts.

32. The landing platform as claimed in claim 25, wherein skids which are enclosed by a landing frame of the drone can be moved by way of the sliding bars into a position parallel to the running direction of the drone conveyor belts.

33. The landing platform as claimed in claim 25, wherein the sliding bars are driven via a chain drive.

34. The landing platform as claimed in claim 25, wherein the sliding bars are made from profiled stainless steel.

35. The landing platform as claimed in claim 25, wherein the sliding bars, when they move away from one another, can push foreign objects situated on the landing surface, for example, small branches or leaves, outward from the landing surface.

36. The landing platform as claimed in claim 25, wherein two end positions of a sliding bar (“outside” and “inside”) are limited mechanically.

37. The landing platform as claimed in claim 25, wherein two end positions of the sliding bars (“outside” and “inside”) are scanned by sensor.

38. The landing platform as claimed in claim 25, wherein, in the case of the movement of the drone into the loading position, a landing frame of the drone is aligned on a stop edge.

39. The landing platform as claimed in claim 25, wherein, in the case of the movement of the drone into the loading position, skids of a landing frame of the drone are moved under two hold-down brackets.

40. The landing platform as claimed in claim 25, wherein reaching of the loading position is scanned by way of a sensor system.

41. The landing platform as claimed in claim 25, wherein hold-down brackets hold a landing frame of the drone while the drone collects an item to be transported that is arranged on the lifting apparatus.

42. The landing platform as claimed in claim 25, wherein the lifting apparatus is configured as a scissors-type lifting table.

43. The landing platform as claimed in claim 41, wherein the scissors-type lifting table can be adjusted vertically via a self-locking spindle drive.

44. The landing platform as claimed in claim 25, wherein end positions of the lifting apparatus are detected via sensors.

45. The landing platform as claimed in claim 25, wherein end positions of the lifting apparatus are secured by way of safety stops against damage.

46. The landing platform as claimed in claim 25, wherein the lifting apparatus is driven via an electric motor and a flange-connected gear mechanism.

47. The landing platform as claimed in claim 25, wherein the landing surface has a size of at least 1.8 m by 1.8 m.

48. The landing platform as claimed in claim 25, wherein the landing platform is controlled by the drone.
